(19) United States
(12) Patent Application Publication
(10) Pub. No.: US 2019/0126454 A1
(43) Pub. Date: May 2, 2019

(54) FRAMING NAIL GUN

(71) Applicant: Martin David John, Brooklyn, NY (US)

(72) Inventor: Martin David John, Brooklyn, NY (US)

(21) Appl. No.: 15/796,872

(22) Filed: Oct. 30, 2017

(51) Int. Cl. B25C 1/06; B25C 7/00

(52) U.S. Cl. CPC B25C 1/06; B25C 7/00

(57) ABSTRACT

The AC-powered framing nail gun is the only product of its kind that provides the unique convenience of a framing nail gun that can be operated without the need for an air supply and without the limitations of battery-powered operation.

### BACKGROUND OF THE INVENTION

### Field of the Invention

The present invention is a hardware device. More specifically, the present invention is an AC-powered framing nail gun.

### Description of the Related Art

There are currently no feasible products on the market that provide a framing nail gun without the limitations of air or battery powered operation. Currently, all nail guns are operated by air power or battery. Air operation involves the problem of providing a source of air power for the gun, which normally involves transporting an air compressor to the job site and running an air hose (possibly hundreds of feet) to the work location. Most battery operated guns have the same limitations faced by all battery-powered devices: limited power and limited battery charge time. The AC-Powered Framing Nail Gun overcomes these limitations. All work sites have a source of AC power, even if provided by a generator; running an electric cable to a work location is much easier than running an air hose

### SUMMARY OF THE INVENTION

The present invention is an AC-powered framing nail gun.

The nail gun includes an electric motor, a trigger, a hook, an electric cord, nails, and an LED light.

It is an object of the present invention to provide a nail gun without the limitations of air or battery powered operation.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of an AC-powered framing nail gun, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

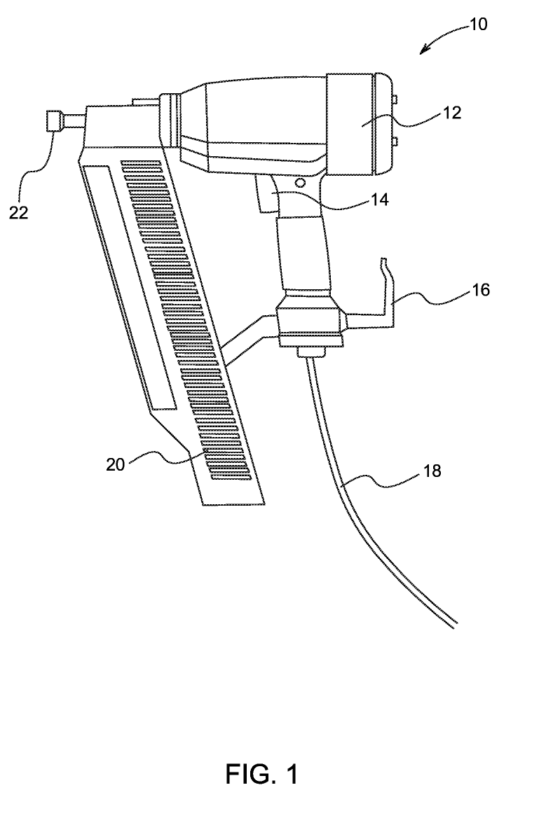

Referring now to FIG. 1, illustrated is a side view of an AC-powered framing nail gun 10, in accordance with one embodiment of the present invention.

In FIG. 1, illustrated is a side view of the an AC-powered framing nail gun 10, including an electric motor 12, a trigger 14, a hook 16, an electric cord 18, nails 20, and an LED light 22. A framing nail gun has an electric motor, a trigger, the trigger coupled to the electric motor, a hook, the hook opposite the trigger and having a protrusion an electric cord, the electric cord extending from a lower end of the framing nail gun a plurality of nails, the plurality of nails being coupled to the framing nail gun; and a light source, the light source is coupled to the framing nail gun. The framing nail gun is used on worksites that have a source of AC power.

One source of power provided to the gun is from a generator. The light source may be an LED light.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A framing nail gun comprising:
an electric motor;
a trigger, the trigger coupled to the electric motor;
a hook, the hook opposite the trigger and having a protrusion;
an electric cord, the electric cord extending from a lower end of the framing nail gun;
a plurality of nails, the plurality of nails being coupled to the framing nail gun; and
a light source, the light source is coupled to the framing nail gun.

2. The framing nail gun according to claim 1, wherein the framing nail gun is used on worksites that have a source of AC power.

3. The framing nail gun according to claim 1, wherein a source of power provided to the gun is from a generator.

4. The framing nail gun according to claim 1, wherein the light source is an LED light.
